(19) United States
(12) Patent Application Publication
(10) Pub. No.: US 2024/0256912 A1
(43) Pub. Date: Aug. 1, 2024

(54) System and Method for Temperature Forecasting for Storage Objects Using Log-Based Classification

(71) Applicant: Dell Products L.P., Round Rock, TX (US)

(72) Inventors: Shaul Dar, Petach Tikva (IL); Ramakanth Kanagovi, Bengaluru (IN); Guhesh Swaminathan, Tamil Nadu (IN); Rajan Kumar, Nawada (IN)

(21) Appl. No.: 18/160,424

(22) Filed: Jan. 27, 2023

(51) Int. Cl. G06N 5/022; G06F 3/06

(52) U.S. Cl. CPC G06N 5/022; G06F 3/061; G06F 3/0659; G06F 3/067

(57) ABSTRACT

A method, computer program product, and computing system for processing a plurality of input/output (IO) requests associated with a plurality of storage objects of a storage system. The plurality of storage objects may be divided into a plurality of classes using a classification-based machine learning model. A temperature for each storage object may be forecast based upon, at least in part, the plurality of classes.

### BACKGROUND

The ability to forecast the future activity of storage objects such as files, volumes, or extents, in a storage system, can enable significant performance gains. For example, it can enable better tiering and caching in a storage array, assist in load balancing across a storage cluster, or help guide data placement and movement in a cloud or combined on-premises and cloud environment. The level of activity is often referred to as the “temperature” of the storage object, where an active object is considered “hot” and an inactive object is considered “cold”. The temperature may be defined in terms of the number of IO operations performed by the storage object in a given time unit, the total number of bytes transferred, or some combination of similar metrics.

The use of a supervised machine learning model using regression to calculate the future temperature forecasts significantly outperforms simpler statistical measures, and can enable tiering or caching with far higher “hit” ratio (i.e. probability of finding the storage object, such as an extent or slice, which is target of the I/O operation, in the top tier or in the cache), and thus with significantly lower average latency. However, in a storage system there can be vast differences between the levels of activity of the storage objects. In a certain time interval, e.g. 5 minutes, some storage objects may receive few IO requests or none at all, while others may receive hundreds of thousands of IO requests—a difference of four or five orders of magnitude. As such, creating a single unified regression model which is accurate across the entire spectrum is highly challenging, and can lead to model underfitting.

### SUMMARY OF DISCLOSURE

In one example implementation, a computer-implemented method executed on a computing device may include, but is not limited to, processing a plurality of input/output (IO) requests associated with a plurality of storage objects of a storage system. The plurality of storage objects may be divided into a plurality of classes using a classification-based machine learning model. A temperature for each storage object may be forecast based upon, at least in part, the plurality of classes.

One or more of the following example features may be included. Dividing the plurality of storage objects into the plurality of classes may include generating a plurality of IO features using the plurality of IO requests. The plurality of IO features may include one or more of: a number of IO requests per second (IOPS); a total number of read IO requests; a total number of write IO requests; a percentage of sequential read IO requests; and a percentage of sequential write IO requests. Dividing the plurality of storage objects into the plurality of classes may include processing the plurality of IO features using the classification-based machine learning model. Dividing the plurality of storage objects into a plurality of classes using a classification-based machine learning model may include determining a class probability for each storage object. Each storage object of the plurality of storage objects may be tiered into a tier of a plurality of tiers based upon, at least in part, the plurality of classes. Tiering each storage object of the plurality of storage objects is further based upon, at least in part, the class probability for each storage object.

In another example implementation, a computer program product resides on a computer readable medium that has a plurality of instructions stored on it. When executed by a processor, the instructions cause the processor to perform operations that may include, but are not limited to, processing a plurality of input/output (IO) requests associated with a plurality of storage objects of a storage system. The plurality of storage objects may be divided into a plurality of classes using a classification-based machine learning model. A temperature for each storage object may be forecast based upon, at least in part, the plurality of classes.

One or more of the following example features may be included. Dividing the plurality of storage objects into the plurality of classes may include generating a plurality of IO features using the plurality of IO requests. The plurality of IO features may include one or more of: a number of IO requests per second (IOPS); a total number of read IO requests; a total number of write IO requests; a percentage of sequential read IO requests; and a percentage of sequential write IO requests. Dividing the plurality of storage objects into the plurality of classes may include processing the plurality of IO features using the classification-based machine learning model. Dividing the plurality of storage objects into a plurality of classes using a classification-based machine learning model may include determining a class probability for each storage object. Each storage object of the plurality of storage objects may be tiered into a tier of a plurality of tiers based upon, at least in part, the plurality of classes. Tiering each storage object of the plurality of storage objects is further based upon, at least in part, the class probability for each storage object.

In another example implementation, a computing system includes at least one processor and at least one memory architecture coupled with the at least one processor, wherein the at least one processor is configured to processing a plurality of input/output (IO) requests associated with a plurality of storage objects of a storage system. The plurality of storage objects may be divided into a plurality of classes using a classification-based machine learning model. A temperature for each storage object may be forecast based upon, at least in part, the plurality of classes.

One or more of the following example features may be included. Dividing the plurality of storage objects into the plurality of classes may include generating a plurality of IO features using the plurality of IO requests. The plurality of IO features may include one or more of: a number of IO requests per second (IOPS); a total number of read IO requests; a total number of write IO requests; a percentage of sequential read IO requests; and a percentage of sequential write IO requests. Dividing the plurality of storage objects into the plurality of classes may include processing the plurality of IO features using the classification-based machine learning model. Dividing the plurality of storage objects into a plurality of classes using a classification-based machine learning model may include determining a class probability for each storage object. Each storage object of the plurality of storage objects may be tiered into a tier of a plurality of tiers based upon, at least in part, the plurality of classes. Tiering each storage object of the plurality of storage objects is further based upon, at least in part, the class probability for each storage object.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a temperature forecasting process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of temperature forecasting process according to one or more example implementations of the disclosure;

FIG. 4 is an example diagrammatic view of the training of a machine learning model according to one or more example implementations of the disclosure;

FIG. 5 is an example diagrammatic view of the dividing of storage objects into classes according to one or more example implementations of the disclosure; and

FIG. 6 is an example diagrammatic view of the tiering of storage objects according to one or more example implementations of the disclosure.

Like reference symbols in the various drawings indicate like elements.

### DETAILED DESCRIPTION

### System Overview:

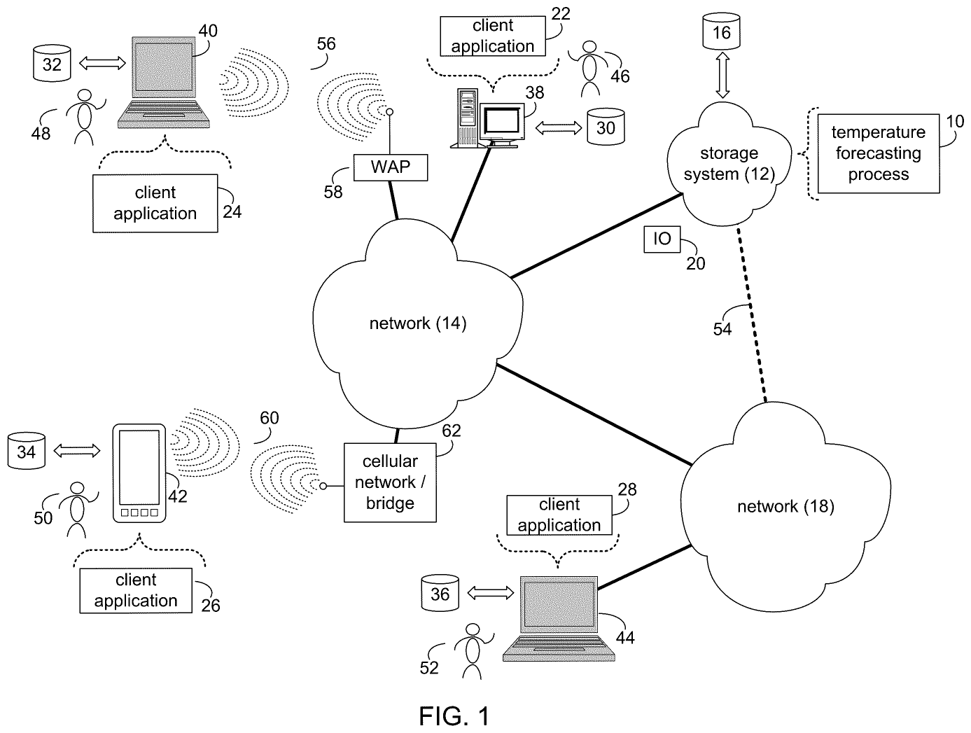

Referring to FIG. 1, there is shown temperature forecasting process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of temperature forecasting process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of temperature forecasting process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a temperature forecasting process, such as temperature forecasting process 10 of FIG. 1, may include but is not limited to, processing a plurality of input/output (IO) requests associated with a plurality of storage objects of a storage system. The plurality of storage objects may be divided into a plurality of classes using a classification-based machine learning model. A temperature for each storage object may be forecast based upon, at least in part, the plurality of classes.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

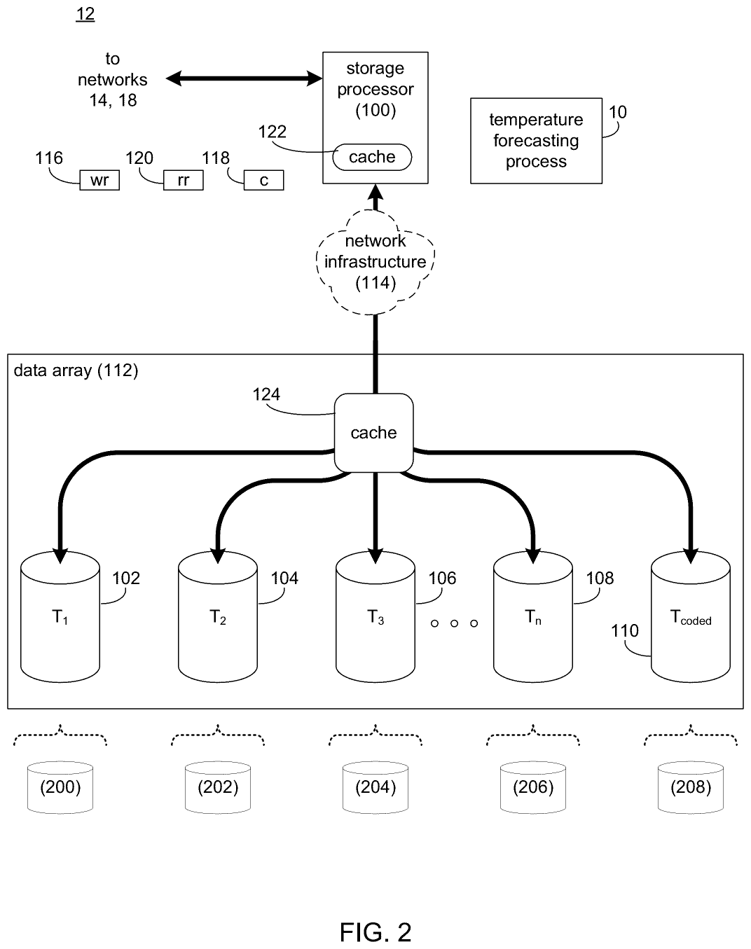

Referring also to FIG. 2, storage system 12 may include storage processor 100 and a plurality of storage targets T 1−n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g. the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of temperature forecasting process 10. The instruction sets and subroutines of temperature forecasting process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices. As discussed above, some portions of the instruction sets and subroutines of temperature forecasting process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, and coded target 110.

As discussed above, the instruction sets and subroutines of temperature forecasting process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of temperature forecasting process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

### The Temperature Forecasting Process:

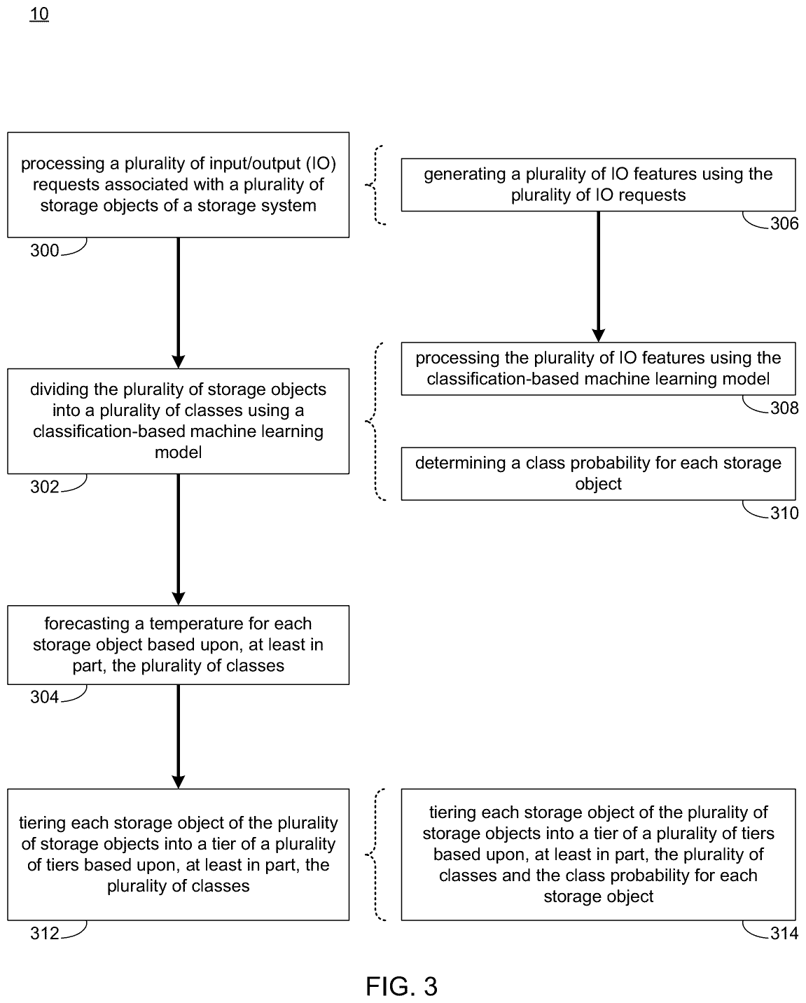

Referring also to the examples of FIGS. 3-6 and in some implementations, temperature forecasting process 10 may process 300 a plurality of input/output (IO) requests associated with a plurality of storage objects of a storage system. The plurality of storage objects may be divided 302 into a plurality of classes using a classification-based machine learning model. A temperature for each storage object may be forecast 304 based upon, at least in part, the plurality of classes.

As will be discussed in greater detail below, implementations of the present disclosure may allow for the use of classification, based on a log scale, instead of regression to forecast the temperature for storage objects. The ability to forecast the future activity of storage objects such as files, volumes, or extents, in a storage system, can enable significant performance gains. For example, it can enable better tiering and caching in a storage array, assist in load balancing across a storage cluster, or help guide data placement and movement in a cloud or combined on-premises and cloud environment. The level of activity is often referred to as the “temperature” of the storage object, where an active object is considered “hot” and an inactive object is considered “cold”. The temperature may be defined in terms of the number of IO operations performed by the storage object in a given time unit, the total number of bytes transferred, or some combination of similar metrics.

The use of a supervised machine learning model using regression to calculate the future temperature forecasts significantly outperforms simpler statistical measures, and can enable tiering or caching with far higher “hit” ratio (i.e. probability of finding the storage object, such as an extent or slice, which is target of the I/O operation, in the top tier or in the cache), and thus with significantly lower average latency. However, in a storage system there can be vast differences between the levels of activity of the storage objects. In a certain time interval, e.g. 5 minutes, some storage objects may receive few IO requests or none at all, while others may receive hundreds of thousands of IO requests—a difference of four or five orders of magnitude. As such, creating a single unified regression model which is accurate across the entire spectrum is highly challenging, and can lead to model underfitting.

As will be discussed in greater detail below, implementations of the present disclosure achieve much higher accuracy, translated also into higher cache hit ratio and lower average latency using log-based classification when compared to regression-based approaches. As such, implementations of the present disclosure: 1) use a classification model for temperature forecasting which, compared to the regression model, is less sensitive and as a result less prone to error and more stable; 2) divide storage objects into classes that are based on the log value of the original continuous regression variable, such as number of I/O operations or total bytes transferred (for either reads or writes) in a given time interval; 3) assigns storage objects into tiers based on combination of the class label and class probability; and 4) is simpler to implement than known regression approaches, with a memory footprint and CPU cost that are significantly lower.

For example, conventional regression approaches use the concept of “bucketizing”, performed on the dataset as the testing results proved that the machine learning model learns better and captures the effect of features better by sub-dividing the dataset into different buckets (thereby controlling the variability in the dataset). Specifically buckets were defined based on the experimental temperature definition, by averaging the total bandwidth values (represented in logical units of 512 bytes). The buckets were created based on the log values, which provided better standardization across each bucket. The distribution of experimental datasets across the various buckets demonstrates that most storage objects are relatively inactive at any time point and most of the IO requests are done by the small active working set of storage objects. For both reads and writes, a single generic model for the entire spectrum is far less accurate (i.e., has far greater error) than using multiple, separate class models, which are then combined to produce a single forecast value. However, this method of bucketizing and then combining the individual models is complex, sensitive, and potentially prone to error (underfitting). Accordingly, temperature forecasting process 10 provides a classification-based machine learning model that solves all these issues, providing a more accurate model that is also simpler and cheaper to train and use.

In some implementations, temperature forecasting process 10 processes 300 a plurality of input/output (IO) requests associated with a plurality of storage objects of a storage system. For example and referring again to FIG. 2, during the operation of a storage system (e.g., storage system 12), IO operations may be generated for processing data on various storage objects (e.g., storage objects 200, 202, 204, 206, 208). Storage objects (e.g., storage objects 200, 202, 204, 206, 208) may generally include any container or storage unit configured to store data within a storage system (e.g., storage system 12). For example, a storage object may be any one of the following: a volume (aka Logical Unit Number (LUN)), a file, or parts thereof that may be defined e.g. by offsets or address ranges (e.g., sub-LUNs, disk extents, and/or slices). In some implementations, the plurality of storage objects include a block storage object and/or a file storage object. A block storage object is a block or chunk of storage that can be accessed by various operating systems. In some implementations, a file storage object is a folder or subset of a hierarchical data structure accessible by a particular path within the hierarchical data structure.

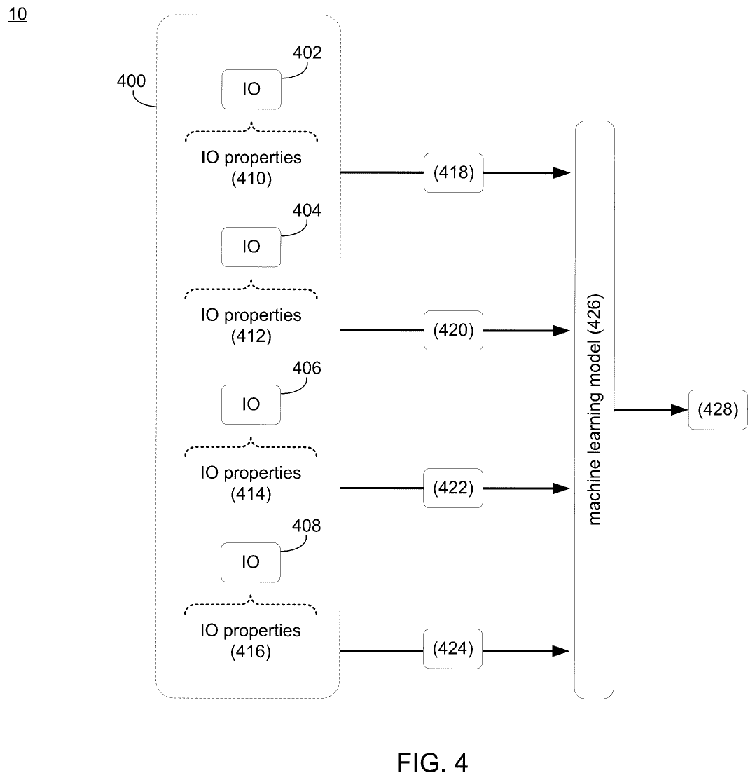

Referring also to FIG. 4, a plurality of IO requests (e.g., plurality of IO requests 400) may include e.g., four IO requests associated with various storage objects and/or the same storage object. IO request 402 may include a request to perform a read IO operation on a first storage object (e.g., storage object 200); IO request 404 may include a request to perform a write IO operation on storage object 200; IO request 406 may include a request to perform a read IO operation on storage object 200; and IO request 408 may include a request to perform an operation on storage object 200. While four separate IO requests for a single storage object have been described, it will be appreciated that this is for example purposes only and that any number of IO requests may be received for any number of storage objects within the present disclosure.

In some implementations, temperature forecasting process 10 generates 306 a plurality of IO features using the plurality of IO requests. An IO feature is a representation of a plurality of IO properties associated with a particular storage object over a period of time. In some implementations, an IO feature is used by a machine learning model to identify trends indicative of a ransomware attack involving the storage object. Examples of IO features include a number of IO requests per second (IOPS); a total number of read IO requests; a total number of write IO requests; a percentage of sequential read IO requests; a percentage of sequential write IO requests; an average length of read IO requests; an average length of write IO requests; a standard deviation in read IO request length; a standard deviation in write IO request length; an average arrival rate of any IO request; an average arrival rate for read IO requests; an average arrival rate for write IO requests; an average difference in logical block address (LBA) between IO requests; an average difference in LBA between consecutive read IO requests; an average difference in logical block address (LBA) between consecutive write IO requests; etc.

In some implementations, temperature forecasting process 10 generates 306 the plurality of IO features by extracting salient data elements (e.g., one or more IO properties) such as volume ID, timestamp, IO command type (e.g. read, write, unmap, etc.), logical block address (LBA) (i.e., an offset in the data path's thin address space), length, pattern (e.g., sequential, random, caterpillar, JO-stride), etc. from the plurality of IO requests. In this manner, temperature forecasting process 10 may extract various IO properties associated with the plurality of IO requests. Referring again to FIG. 4 and in some implementations, temperature forecasting process 10 may extract one or more IO properties from plurality of IO requests 400. For example, temperature forecasting process 10 may extract IO properties 418 from IO request 402; IO properties 420 from IO request 404; IO properties 422 from IO request 406; and IO properties 424 from IO request 408.

In some implementations, generating 306 the plurality of IO features using the plurality of IO requests includes aggregating the plurality of IO requests periodically, and generating the plurality of IO features using the aggregated plurality of IO requests. For example, temperature forecasting process 10 may aggregate the one or more IO properties periodically to optimize for memory/storage requirements and/or CPU costs. Additionally, temperature forecasting process 10 may use a sampling approach where IO properties for every “n”th IO request are extracted. In some implementations, the number of IO requests between extracting the one or more IO properties may be user-defined, a default number of IO requests, and/or defined automatically by temperature forecasting process 10. In this manner, temperature forecasting process 10 may limit the amount of processing of IO requests to generate IO features by sampling and aggregating a limited set of all of the IO requests received at the storage system. Referring again to FIG. 4 and in some implementations, temperature forecasting process 10 may aggregate IO properties 410 from IO request 402; IO properties 412 from IO request 404; IO properties 414 from IO request 406; and IO properties 416 from IO request 408 and generate a plurality of IO features (e.g., IO features 418, 420, 422, 424).

In some implementations, temperature forecasting process 10 may divide 302 the plurality of storage objects into a plurality of classes using a classification-based machine learning model. A machine learning model may generally include an algorithm or combination of algorithms that has been trained to recognize certain types of patterns. For example, machine learning approaches may be generally divided into three categories, depending on the nature of the signal available: supervised learning, unsupervised learning, and reinforcement learning. Supervised learning may include presenting a computing device with example inputs and their desired outputs, given by a “teacher”, where the goal is to learn a general rule that maps inputs to outputs. With unsupervised learning, no labels are given to the learning algorithm, leaving it on its own to find structure in its input. Unsupervised learning can be a goal in itself (discovering hidden patterns in data) or a means towards an end (feature learning). Reinforcement learning may generally include a computing device interacting in a dynamic environment in which it must perform a certain goal (such as driving a vehicle or playing a game against an opponent). As it navigates its problem space, the machine learning model is provided feedback that is analogous to rewards, which it tries to maximize. While three examples of machine learning approaches have been provided, it will be appreciated that other machine learning approaches are possible within the scope of the present disclosure.

In some implementations, temperature forecasting process 10 divides 302 the plurality of storage objects into a plurality of classes using a classification-based machine learning model. A classification-based machine learning model (e.g., machine learning model 426) is a machine learning model configured to classify storage objects into classes based on the plurality of IO requests processed for that storage object. In some implementations, the classification-based machine learning model assigns or divides a storage object into a particular class using a logarithmic-based or logarithmic scale-based representation of a continuous variable (e.g., the number of IO requests, total amount of data transferred by IO requests, etc.) in a given time interval. For example, as opposed to determining a temperature for each storage object as a particular value using a continuous regression variable, temperature forecasting process 10 determines a log-based value of the continuous variables discussed above and generates a plurality of classes to represent the various log-based values. Referring again to FIG. 4 and in some implementations, temperature forecasting process 10 may process 308 the plurality of IO features (e.g., IO features 418, 420, 422, 424) using a classification-based machine learning model (e.g., machine learning model 426).

In some implementations, dividing 302 the plurality of storage objects into the plurality of classes includes processing 308 the plurality of IO features using the classification-based machine learning model. For example, temperature forecasting process 10 processes the plurality of IO features (e.g., a number of IO requests per second (IOPS); a total number of read IO requests; a total number of write IO requests; a percentage of sequential read IO requests; a percentage of sequential write IO requests; an average length of read IO requests; an average length of write IO requests; a standard deviation in read IO request length; a standard deviation in write IO request length; an average arrival rate of any IO request; an average arrival rate for read IO requests; an average arrival rate for write IO requests; an average difference in logical block address (LBA) between IO requests; an average difference in LBA between consecutive read IO requests; an average difference in logical block address (LBA) between consecutive write IO requests, etc.) to generate logarithmic-based values. Temperature forecasting process 10 uses these logarithmic-based values to generate a plurality of classes. For example, suppose temperature forecasting process 10 generates an IO feature that includes a read bandwidth value over a particular interval of time. From this IO feature, temperature forecasting process 10 may generate log-based read bandwidth values and group these values to form a plurality of classes.

In some implementations, each class may represent the likelihood or probability that a particular storage object may be accessed (i.e., read from and/or written to) within a given time interval. For example, when processing the plurality of IO features, temperature forecasting process 10 may classify the likelihood or probability that a particular storage object will be accessed as a plurality of classes indicative of respective probability ranges. For instance, a storage object that is determined to be unlikely to be accessed within a particular time interval (e.g., based on thresholds or weights) may be classified into a first class while a storage object that is determined to be very likely to be accessed within a particular time interval (e.g., based on thresholds or weights) may be classified into a second class. As will be discussed in greater detail below, temperature forecasting process 10 may associate each class with a temperature value indicative of a temperature of a storage object.

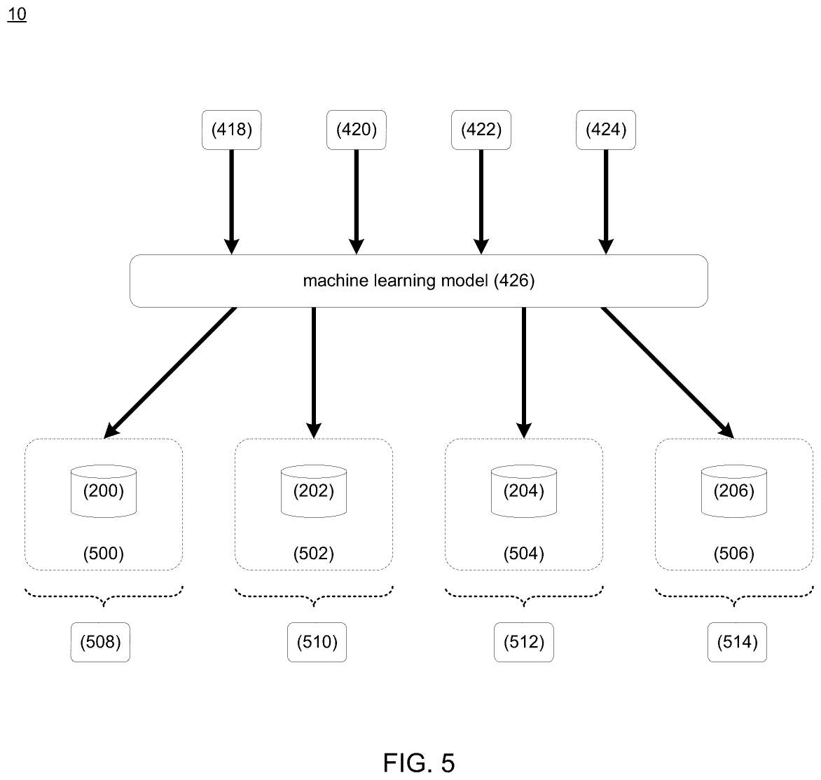

Referring also to FIG. 5, suppose that temperature forecasting process 10 processes a plurality of IO features (e.g., IO features 418, 420, 422, 424) for a plurality of storage objects (e.g., storage objects 200, 202, 204, 206) using a classification-based machine learning model (e.g., machine learning model 426). In this example, temperature forecasting process 10 may use IO features 418, 420, 422, 424 to generate log-based values. Temperature forecasting process 10 may group these log-based values into a plurality of classes (e.g., classes 500, 502, 504, 506). With the plurality of classes (e.g., classes 500, 502, 504, 506), temperature forecasting process 10 may divide 302 the plurality of storage objects (e.g., storage objects 200, 202, 204, 206) among the plurality of classes. For example, suppose that temperature forecasting process 10 divides storage object 200 into class 500; storage object 202 into class 502; storage object 204 into class 504; and storage object into class 506. Further, suppose that for a plurality of storage objects, temperature forecasting process 10 determines a distribution of storage objects into classes 500, 502, 504, and 506 as follows: 90.36% in class 500; 6.01% in class 502; 2.18% in class 504; and 1.46% in class 506. In this example, the vast majority of storage objects may be in class 500, which is indicative of many storage objects with e.g., low read bandwidth. While this example includes four classes, it will be appreciated that temperature forecasting process 10 may divide 302 the plurality of storage objects into any number of classes within the scope of the present disclosure. In some implementations, the number of and/or distribution characteristics of each class may be user-defined, a default value or set of values, and/or determined by temperature forecasting process 10.

In some implementations, the class distribution may be highly skewed. As such, temperature forecasting process 10 may impute class weights to the classification-based machine learning model for better learning. For example, the weights of the classifier may be set based on the distribution of the data as shown below in Equation 1:

$${W}_{j} = {n}_{s a m p l e s} / ( {n}_{c l a s s e s} * {n}_{j samples} ) \qquad ( 1 )$$

where j represents each class, Wⱼ is the weight for each class, nₛₐₘₚₗₑₛ is the total number of samples in the dataset, n_{classes} is the total number of unique classes, and n_{j samples} is the total number of samples of the respective class (j).

For the example distribution above (i.e., 90.36% in class 500; 6.01% in class 502; 2.18% in class 504; and 1.46% in class 506), temperature forecasting process 10 determines the following weights: 0.276 for class 500; 4.218 for class 502; 11.764 for class 504; and 17.908 for class 506. These weights may be utilized by the weighted classifier to get a better accuracy than the normal (non-weighted) classifier. In one example, suppose the classification-based machine learning model is a Random Forest classifier. In this example, temperature forecasting process 10 may perform hyper-parameter tuning for the Number of Trees and Max Depth, using a grid-search technique to obtain optimal values, balancing the accuracy and the memory/CPU footprint. However, it will be appreciated that various hyper-parameters may be tuned for various types of classification-based machine learning models within the scope of the present disclosure.

In some implementations, dividing 302 the plurality of storage objects into a plurality of classes using a classification-based machine learning model includes determining 310 a class probability for each storage object. For example, when dividing 302 the plurality of storage objects into the plurality of classes using the classification-based machine learning model, the classification-based machine learning model may determine a class probability (i.e., a probability percentage or score between 0 and 1) that determines the probability that the storage object belongs to a particular class. As discussed above, suppose each class represents a grouping of log-based values representative of the activity of the storage object based on the plurality of IO features (e.g., class 500 represents the least active storage objects; class 506 represents the most active storage objects; and classes 502 and 504 represent storage objects with different thresholds of activity relative to classes 500 and 506). Accordingly, when making this activity prediction, the classification-based machine learning model may determine a probability score that a given storage object has the requisite activity of a particular class. For example, suppose that when processing the plurality of IO features in the above described example for storage objects 200, 202, 204, and 206, that temperature forecasting process 10 determines the following class probabilities as shown in Table 1:

TABLE 1

| | Class 500 | Class 502 | Class 504 | Class 506 |
|---|---|---|---|---|
| Storage object | 89.1% | 5.4% | 3.6% | 1.9% |
| 200 | | | | |
| Storage object | 30.1% | 59.8% | 6.7% | 3.4% |
| 202 | | | | |
| Storage object | 1.2% | 28.5% | 62.1% | 8.2% |
| 204 | | | | |
| Storage object | 0.1% | 3.1% | 18.2% | 78.6% |
| 206 | | | | |

As shown above in Table 1, temperature forecasting process 10 may determine 310 a class probability for each storage object for each class. Referring again to FIG. 5, temperature forecasting process 10 may determine 310 class probability 508 for storage object 200; class probability 510 for storage object 202; class probability 512 for storage object 204; and class probability for storage object 206. As will be discussed in greater detail below, temperature forecasting process 10 may use these class probabilities to tier storage objects among respective tiers.

In some implementations, temperature forecasting process 10 may forecast 304 a temperature for each storage object based upon, at least in part, the plurality of classes. Forecasting 304 a temperature of a storage object may include generating a temperature value indicative of a likelihood that a storage object will be accessed within a particular time frame. The temperature may incorporate the number of IO requests performed against the storage object, as well as the number of bytes transferred, within the relevant time frame. For example, the temperature value may include a read temperature, a write temperature, and/or a combination of a read and write temperature. That is, a temperature value may indicate a likelihood that data may be read from a storage object and/or that data may be written to a storage object within a particular time frame. In some implementations, the temperature value may be utilized by various tiering or caching policies to optimize the tiering or caching of the storage objects within the storage system. For example, the temperature prediction may enable various tiering or caching policies that use the predicted temperature, along with other values such as the system parameters (e.g., the tiering hierarchy topology, sizes of various layers, etc.), to optimize (up or down) tiering or caching decisions, resulting in a performance gain.

In some implementations, forecasting 304 the temperature for a storage object may include associating a temperature value with each storage object based upon, at least in part, the plurality of classes. For example and as discussed above, suppose that temperature forecasting process 10 divides 302 the plurality of storage objects into a plurality of classes based upon, at least in part, the plurality of IO features. In this example, each class may represent a grouping of log-based values for the plurality of IO features indicative of the likelihood that a storage object will be accessed (e.g., read from and/or written to) within a particular time interval. Referring again to FIG. 5 and the above example, suppose temperature forecasting process 10 divides 302 storage objects 200, 202, 204, 206 into classes 500, 502, 504, 506. As discussed above, each of classes 500, 502, 504, 506 may represent a likelihood or probability that a storage object within that class will be accessed (e.g., read from and/or written to) within a particular time interval. Accordingly, temperature forecasting process 10 may associate a temperature value or range with each class.

For example, suppose class 500 represents a first grouping of storage objects including the least accessed (e.g., in terms of read access, write access, or both) storage objects; class 502 represents a second grouping of storage objects that are accessed more frequently than those of class 500 but less than those of class 504; class 504 represents a third grouping of storage objects that are accessed more frequently than those of class 502 but less than those of class 506; and class 506 represents a fourth grouping of storage objects that are accessed more frequently than those of class 504. In this example, temperature forecasting process 10 may associate each class with a temperature value. For example, temperature forecasting process 10 may associate a first temperature value (i.e., “archive”) with class 500; a second temperature value (i.e., “cold”) with class 502; a third temperature value (i.e., “warm”) with class 504; and a fourth temperature value (i.e., “hot”) with class 506. In some implementations, temperature forecasting process 10 may use user-defined thresholds or default thresholds for defining each temperature value. For example, various log-based values may define the respective thresholds between temperature values.

In some implementations, the forecasted temperature value of each storage object may be correlated with storage system performance gain if a tiering operation to a particular tier (e.g., up-tiering/promotion to highest tier or down-tiering/demotion to lowest tier) is applied to that storage object. For example, if a storage object is accessed more frequently, IO requests for that storage object will be most efficiently processed using a higher performance storage tier. By contrast, if a storage object is accessed infrequently, IO requests for that storage object may be efficiently processed using a lower performance storage tier. As such, it will be appreciated that temperature forecasting process 10 may use the forecasted temperature value to perform various operations (i.e., tiering, caching, ransomware detection, etc.) to enhance the performance and/or security of a storage system.

In some implementations, temperature forecasting process 10 may tier 312 each storage object of the plurality of storage objects into a tier of a plurality of tiers based upon, at least in part, the plurality of classes. Tiering may generally include the movement or relocation of data from one storage tier to another storage tier based upon, at least in part, the frequency of data usage or the expected frequency of data usage. For example and as discussed above, different storage tiers may be designed for various performance levels. Using the specific example of SSDs, once data is identified as frequently used, the identified blocks of data may be moved in the background to the SSD rather than being copied, since the SSD is being utilized as a primary storage tier, not a look aside copy area. When the data is subsequently accessed, the IO requests directed to the data may occur at or near the native performance of the SSDs.

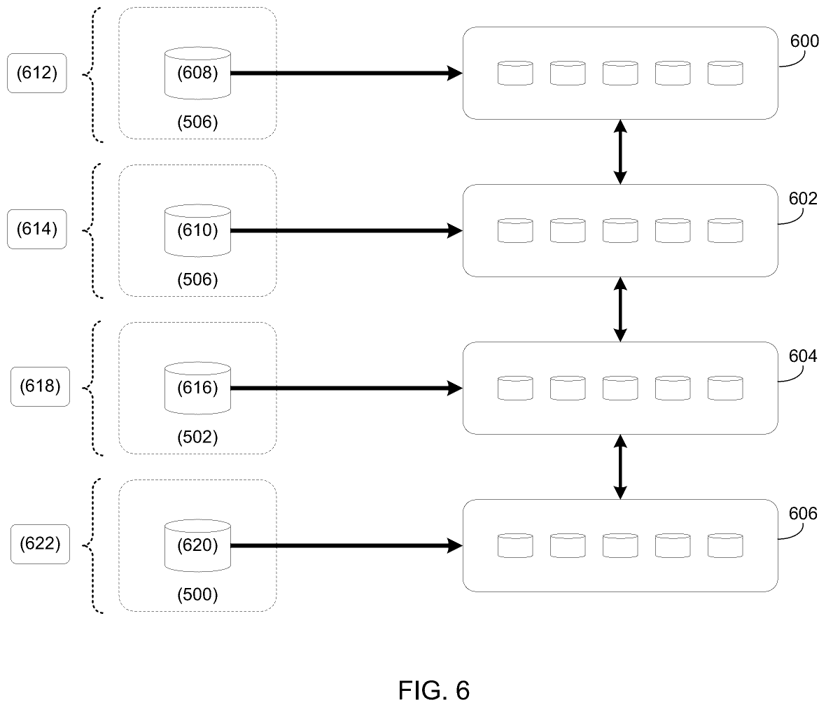

Referring also to FIG. 6 and in some implementations, suppose storage system 12 includes or has access to e.g., four different storage tiers (e.g., storage tiers 600, 602, 604, 606) with four different performance levels. For example, storage tier 600 may be associated with a high level performance storage tier (e.g., NVRAM); storage tier 602 may be associated with a mid-level performance storage tier (e.g., SSD); storage tier 604 may be associated with a low level performance storage tier (e.g., HDD); and storage tier 606 may be associated with an off premise, low level performance storage tier (e.g., cloud storage).

For example, storage tier 606 may include cloud storage tiering. Temperature forecasting process 10 may provide data movement between on premise storage tiers (e.g., storage tiers 600, 602, 604) and private or public cloud storage (e.g., storage tier 606), and data movement between multiple cloud storage service types, by treating the cloud storage services as additional storage tiers with known retrieval times, transfer and storage costs, much like local media such as tape archives. Accordingly, temperature forecasting process 10 may provide for tiering between any number of or type of storage tiers within the scope of the present disclosure.

As each storage object may be accessed at various times and frequencies throughout the life cycle of the storage object, temperature forecasting process 10 may tier or re-tier the storage object in various storage tiers corresponding to the degree that the storage object is accessed or predicted to be accessed. Accordingly, temperature forecasting process 10 may define a temperature value indicative of the likelihood that a storage object will be accessed within a particular time frame using the plurality of classes.

In some implementations, temperature forecasting process 10 may tier the one or more storage objects between a plurality of storage tiers of the storage system, based upon, at least in part, the plurality of classes. As discussed above, various temperature values may be defined for the storage objects. Temperature forecasting process 10 may utilize the temperature values of each class to determine which storage tier of a plurality of storage tiers to tier the storage objects to. For example, temperature forecasting process 10 may define a plurality of tiering thresholds for the plurality of storage tiers using the temperature values for the storage objects. As will be discussed in greater below, the plurality of tiering thresholds may indicate which storage tier to tier storage objects within.

A tiering policy may generally include a rule or portion of logic that determines how a storage object is tiered within a storage system. Tiering policies may be user-defined and/or automatically define by temperature forecasting process 10. As discussed above, tiering policies may utilize the temperature value defined by the one or more machine learning models along with other system parameters (e.g., the tiering hierarchy topology, sizes of various layers, etc.), to optimize tiering decisions. For example, tiering policies may define when to promote or up-tier particular storage objects to a higher performance storage tier based upon, the temperature value defined for the storage objects and performance characteristics of the storage system. Similarly, tiering policies may define when to demote or down-tier particular storage objects to a lower performance storage tier based upon, the temperature value defined for the storage objects and performance characteristics of the storage system. In this manner, temperature forecasting process 10 may optimize the tiering of storage objects by enabling particular tiering policies for specific storage objects using the temperature values defined for the storage objects.

In some implementations, temperature forecasting process 10 may define a plurality of tiering thresholds based upon, at least in part, the temperature values or classes for each storage object. For example, temperature forecasting process 10 may define a first tiering threshold for “cold” storage objects; a second tiering threshold for “warm” storage objects; and a third tiering threshold for “hot” storage objects. While an example of three tiering thresholds has been described (e.g., “cold”, “warm”, and “hot” thresholds), it will be appreciated that temperature forecasting process 10 may define any number of tiering thresholds within the scope of the present disclosure.

Temperature forecasting process 10 may define the number of and/or values of the plurality of tiering thresholds in terms of temperature values based upon, at least in part, a defined capacity for each storage tier, the performance capability of each storage tier, the number of storage tiers, and/or data efficiency operations associated with storage of data on a particular storage tier (e.g., data compression, data deduplication, etc. associated with each storage tier). The tiering threshold for each storage tier may be defined with an initial threshold, a default threshold, a user-defined threshold (e.g., input via a user interface), and/or may be an automatically defined threshold (e.g., generated by temperature forecasting process 10).

In some implementations, tiering 314 each storage object of the plurality of storage objects may be further based upon, at least in part, the class probability for each storage object. For example, conventional regression models calculate a continuous temperature value, thus defining a total order, or ranking, among the storage objects. The assignment of storage objects to tiers can be based on this value. In the case of the classification model, each storage object is assigned to a class, thus defining a partial order among the storage objects (i.e., temperature in terms of assignment to a particular class but not inter-class ranking or ordering). To achieve the assignment of storage objects into tiers, temperature forecasting process 10 may use the combination of the class label (i.e., designation of which class a storage object has been assigned to) and the class probability.

For example, suppose class 506 includes a plurality of storage objects as discussed above. In this example, the class label of class 506 does not, on its own, effectively order the temperature of each storage object within class 506. As such, temperature forecasting process 10 may use the class probability to order each storage object within each class. Referring also to FIG. 6, suppose that temperature forecasting process 10 divides storage objects 608 and 610 into class 506 with class probabilities 612, 614 of 95.4% and 51.2%, respectively; storage object 616 into class 502 with class probability 618 of 76.8%; and storage object 620 into class 500 with class probability 622 of 84.1%. In this example, suppose that temperature forecasting process 10 is tiering 314 storage objects 608, 610, 616, and 620 into tiers 600, 602, 604, and 606. Suppose that class 506 is associated with a “hot” temperature value; class 504 is associated with a “warm” temperature value; class 502 is associated with a “cold” temperature value; and class 500 is associated with a minimal or “archive” temperature value. In this example, temperature forecasting process 10 may attempt to tier storage objects 608 and 610 to storage tier 600. However, storage tier 600 may only have sufficient availability for a single storage object. Accordingly, temperature forecasting process 10 may use the combination of class label and class probability to tier 314 each storage object of class 506. For example, because storage object 608 has class probability 612 that exceeds class probability 614 of storage object 610, temperature forecasting process 10 may tier 314 storage object 608 in storage tier 600 and storage object 610 in storage tier 602. Temperature forecasting process 10 may tier 314 storage object 616 from class 502 associated with a “low” temperature value to tier 604 associated with a “low” temperature value and storage object 620 from class 500 associated with an “archive” temperature value to tier 606 associated with an “archive” temperature value.

Referring also to Table 2, a comparison is shown of the regression and classification model results along with a simple moving average-based (SMA-based) determination as a baseline. Since there is not a direct way to compare the error of regression versus classification methods, rank correlation is used. For example, the ideal ranking of the storage objects is assumed on a perfect prediction based on the read bandwidth of each storage object in the test dataset, highest to lowest. The rank correlation measures the degree of agreement between the forecasted order by temperature using each method (SMA, regression, or classification) versus the ideal rank order. SMA has a poor rank correlation, the regression method provides a major improvement, and the classification method is significantly better. In the next four columns, the hit ratio (i.e., percentage of IO requests served from the cache, or top tier) is also greatly improved by the new classification method, in all four measurements (e.g., reads vs writes, IO operations versus bytes transferred). The projected latency is also shown assuming a simple tiering method that pushes the hottest (⅛) slices to the top tier, leaving the others in the bottom tier. Again, the classification model shows a major improvement over the earlier regression model:

TABLE 2

| | | Hit | Hit | Hit | Hit | | |
|---|---|---|---|---|---|---|---|
| | Rank | Ratio % - | Ratio % - | Ratio % - | Ratio % - | Latency | |
| | Correlation | Read_BW | Total_BW | Read_IO | Total_IO | in ms | |
| Ideal | | 99.54% | 87.19% | 89.95% | 72.12% | 0.07 | ms |
| Classification | 0.54 | 82.85% | 77.49% | 63.22% | 51.82% | 0.229 | ms |
| Regression | 0.36 | 50.31% | 43.81% | 60.72% | 49.89% | 0.53 | ms |
| with eight | | | | | | | |
| buckets | | | | | | | |
| SMA | −0.08 | 46.00% | 42.05% | 51.20% | 42.97% | 0.57 | ms |

Table 3 below provides a comparison of the regression and classification model cost. The classification model of the subject disclosure is much more cost effective than the previous regression model in terms of memory footprint and training and test (inference) CPU overhead:

TABLE 3

| | Memory - | CPU times - | CPU times - | Wall times - | Wall times - |
|---|---|---|---|---|---|
| | Training | Training | Testing | Training | Testing |
| Classification | 1.2 GB | 794 ms | 52.9 ms | 7 min 22 s | 5.05 s |
| Regression | 5.6 GB | 4.08 s | 245.1 ms | 16 min 44 s | 6.90 s |
| with 8 | | | | | |
| Buckets | | | | | |

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
processing a plurality of input/output (IO) requests associated with a plurality of storage objects of a storage system;
dividing the plurality of storage objects into a plurality of classes using a classification-based machine learning model; and
forecasting a temperature for each storage object based upon, at least in part, the plurality of classes.

2. The computer-implemented method of claim 1, wherein dividing the plurality of storage objects into the plurality of classes includes generating a plurality of IO features using the plurality of IO requests.

3. The computer-implemented method of claim 2, wherein the plurality of IO features include one or more of:
a number of IO requests per second (IOPS);
a total number of read IO requests;
a total number of write IO requests;
a percentage of sequential read IO requests; and
a percentage of sequential write IO requests.

4. The computer-implemented method of claim 2, wherein dividing the plurality of storage objects into the plurality of classes includes processing the plurality of IO features using the classification-based machine learning model.

5. The computer-implemented method of claim 1, wherein dividing the plurality of storage objects into a plurality of classes using a classification-based machine learning model includes determining a class probability for each storage object.

6. The computer-implemented method of claim 5, further comprising:
tiering each storage object of the plurality of storage objects into a tier of a plurality of tiers based upon, at least in part, the plurality of classes.

7. The computer-implemented method of claim 6, wherein tiering each storage object of the plurality of storage objects is further based upon, at least in part, the class probability for each storage object.

8. A computer program product residing on a non-transitory computer readable medium having a plurality of instructions stored thereon which, when executed by a processor, cause the processor to perform operations comprising:
processing a plurality of input/output (IO) requests associated with a plurality of storage objects of a storage system;
dividing the plurality of storage objects into a plurality of classes using a classification-based machine learning model; and
forecasting a temperature for each storage object based upon, at least in part, the plurality of classes.

9. The computer program product of claim 8, wherein dividing the plurality of storage objects into the plurality of classes includes generating a plurality of IO features using the plurality of IO requests.

10. The computer program product of claim 9, wherein the plurality of IO features include one or more of:
a number of IO requests per second (IOPS);
a total number of read IO requests;
a total number of write IO requests;
a percentage of sequential read IO requests; and
a percentage of sequential write IO requests.

11. The computer program product of claim 9, wherein dividing the plurality of storage objects into the plurality of classes includes processing the plurality of IO features using the classification-based machine learning model.

12. The computer program product of claim 8, wherein dividing the plurality of storage objects into a plurality of classes using a classification-based machine learning model includes determining a class probability for each storage object.

13. The computer program product of claim 12, wherein the operations further comprise:
tiering each storage object of the plurality of storage objects into a tier of a plurality of tiers based upon, at least in part, the plurality of classes.

14. The computer program product of claim 13, wherein tiering each storage object of the plurality of storage objects is further based upon, at least in part, the class probability for each storage object.

15. A computing system comprising:
a memory; and
a processor configured to process a plurality of input/output (IO) requests associated with a plurality of storage objects of a storage system, wherein the processor is further configured to divide the plurality of storage objects into a plurality of classes using a classification-based machine learning model, and wherein the processor is further configured to forecast a temperature for each storage object based upon, at least in part, the plurality of classes.

16. The computing system of claim 15, wherein dividing the plurality of storage objects into the plurality of classes includes generating a plurality of IO features using the plurality of IO requests.

17. The computing system of claim 16, wherein the plurality of IO features include one or more of:
a number of IO requests per second (IOPS);
a total number of read IO requests;
a total number of write IO requests;
a percentage of sequential read IO requests; and
a percentage of sequential write IO requests.

18. The computing system of claim 16, wherein dividing the plurality of storage objects into the plurality of classes includes processing the plurality of IO features using the classification-based machine learning model.

19. The computing system of claim 15, wherein dividing the plurality of storage objects into a plurality of classes using a classification-based machine learning model includes determining a class probability for each storage object.

20. The computing system of claim 19, wherein the processor is further configured to:
tier each storage object of the plurality of storage objects into a tier of a plurality of tiers based upon, at least in part, the plurality of classes.
